(19) United States
(12) Patent Application Publication
(10) Pub. No.: US 2016/0123824 A1
(43) Pub. Date: May 5, 2016

(54) Full Load Brake Torque Inspection Method

(71) Applicants: Ji An Wan, Guangzhou (CN); Kaisheng David Xu, Guangzhou Guangdong (CN)

(72) Inventors: Ji An Wan, Guangzhou (CN); Kaisheng David Xu, Guangzhou Guangdong (CN)

(21) Appl. No.: 14/412,906

(22) PCT Filed: Jul. 9, 2012
(86) PCT No.: PCT/CN2012/078342

§ 371 Date: Oct. 28, 2015

(51) Int. Cl. G01L 5/28; B25B 23/142; F16D 66/00

(52) U.S. Cl. CPC G01L 5/28; F16D 66/00; B25B 23/1427; F16D 2066/005

(57) ABSTRACT

A brake torque inspection method to a device having a drive machine and a driven component operatively connected to the drive machine is disclosed. The method comprises applying a brake to the driven component, and using a torque wrench at a shaft of the drive machine to determine the brake torque.

### CROSS-REFERENCE TO RELATED APPLICATION

This is a 35 U.S.C. §371 US National Stage filing of International Patent Application No. PCT/CN2012/078342 filed on Jul. 9, 2012.

### FIELD OF THE DISCLOSURE

The present disclosure relates generally to passenger conveyors and, more particularly, to methods for brake torque inspection.

### BACKGROUND OF THE DISCLOSURE

Modern buildings may include different types of passenger conveyors, namely, elevators, escalators and moving walkways. These devices have made moving within large buildings such as skyscrapers, airports and shopping malls faster, easier and more efficient.

Escalators and moving walkways may occasionally need to be stopped for maintenance. When an escalator or moving walkway is stopped, two things must occur. First, the motor powering the escalator or walkway, typically a powerful electrical motor, is deactivated. Second, at essentially the same time, a primary brake is applied to prevent movement of the escalator or walkway until it is reactivated for use. Because of the importance of proper braking, it is typical to equip passenger conveyors with a second braking system to compliment the primary braking system, namely, an auxiliary braking system.

While the primary brake is typically located in the drive system and is used for routine stopping and holding of escalators, the auxiliary brake is an additional safety brake, usually found in the main drive assembly in the upper landing area. Auxiliary brakes are activated in accordance with local safety codes when conditions warrant. Both braking systems require periodic inspection, repair, and maintenance.

Conventionally, to inspect the brake torque of the auxiliary braking system, significant weight is placed on the steps of the escalator, which is then operated under normal conditions. Next, the brakes of the escalator are set, and the maintenance operators observe whether or not the auxiliary braking system can stop the required weight load on the escalator. From there, they can establish whether the auxiliary braking system meets the standard braking torque value required by local safety codes based on the weight of the load and function of the auxiliary brakes. This conventional method, however, requires a considerable amount of manpower, as well as time, to physically lift, load and unload the heavy weights.

Thus, there exists a need for a simplified, efficient and reliable brake torque inspection method for escalator systems.

### SUMMARY OF THE DISCLOSURE

In an exemplary embodiment, a brake torque inspection method to a device having a drive machine and a driven component operatively connected to the drive machine is disclosed. The method may comprise applying a brake to the driven component, and using a torque wrench at a shaft of the drive machine to determine the brake torque.

The drive machine may have a motor shaft and an output shaft. The method may further comprise using the torque wrench at the motor shaft to determine the torque at the drive machine. The method may further comprise using the torque wrench at the output shaft to determine the torque at the drive machine. The method may further comprise multiplying the obtained torque measurement at the motor by a transmission ratio to determine the brake torque. Further, the method may comprise comparing the determined brake torque to a minimum amount of brake torque required by local safety codes for a passenger conveyor. The brake and the drive machine may be components of a passenger conveyor. The transmission ratio may depend on at least one transmission element configured to transfer power from the drive machine to a main drive shaft, the at least one transmission element comprising a gearbox, machine drive sprocket, main drive chain, and main drive sprocket. The method may further comprise applying a predetermined torque value by the torque wrench to the shaft to determine if the predetermined torque will cause the shaft to turn, wherein the predetermined torque value is calculated from multiplying a minimum amount of brake torque required by local safety codes for a passenger conveyor by a transmission ratio.

In another exemplary embodiment, a method for inspecting the brake torque in a passenger conveyor is disclosed. The method may comprise setting an auxiliary brake of a passenger conveyor in a braking position, the auxiliary brake being operatively associated to a drive machine of the passenger conveyor. The method may further comprise applying a torque wrench to the drive machine to determine the brake torque.

The braking position may be a position in which the auxiliary brake stops the passenger conveyor from moving. The drive machine may include a motor shaft, and the torque wrench may be applied to the motor shaft of the drive machine. The torque wrench may be adapted to engage with an end of the motor shaft at the top of a motor of the drive machine. The drive machine may include an output shaft, and the torque wrench may be applied to the output shaft of the drive machine. A torque at the drive machine may be determined by applying the torque wrench to the drive machine. The method may further comprise multiplying the torque at the drive machine by a transmission ratio to determine the brake torque. The transmission ratio may depend on at least one transmission element configured to transfer power from the drive machine to a main drive shaft of the passenger conveyor, the at least one transmission element comprising a gearbox, machine drive sprocket, main drive chain, and main drive sprocket. The auxiliary brake may be configured to stop the main drive shaft of the passenger conveyor. The method may further comprise comparing the determined brake torque to a minimum amount of brake torque required by local safety codes. The method may further comprise applying a predetermined torque value by the torque wrench to the shaft to determine if the predetermined torque will cause the shaft to turn, wherein the predetermined torque value is calculated from multiplying a minimum amount of brake torque required by local safety codes for a passenger conveyor by a transmission ratio.

In yet another exemplary embodiment, a method for testing brake torque in a passenger conveyor is also disclosed. The method may comprise providing a passenger conveyor with a brake, a main drive shaft, and a drive machine. The method may further comprise applying the brake to the main drive shaft and using a torque wrench at the drive machine to test the brake torque, the drive machine being operatively configured to move the main drive shaft.

A drive machine torque may be determined by the torque wrench. The method may further comprise multiplying the drive machine torque by a transmission ratio to determine the brake torque. The method may further comprise comparing the determined brake torque to an acceptable value of brake torque for the passenger conveyor required by local safety codes. The method may further comprise applying a predetermined torque value by the torque wrench to the shaft to determine if the predetermined torque will cause the shaft to turn, wherein the predetermined torque value is calculated from multiplying a minimum amount of brake torque required by local safety codes for a passenger conveyor by a transmission ratio. The drive machine may include a motor shaft and an output shaft, and the torque wrench may be applied to either the motor shaft or the output shaft. The passenger conveyor may comprise an escalator, a moving walkway, or an elevator.

These and other aspects and features of the invention will become more readily apparent upon reading the following detailed description when taken in conjunction with the accompanying drawings. Although various features are disclosed in relation to specific exemplary embodiments of the invention, it is understood that different embodiments of the invention are not mutually exclusive, and the various features may be combined with each other, or used alone, with any of the various exemplary embodiments of the invention without departing from the scope of the invention.

### BRIEF DESCRIPTION OF THE DRAWINGS

FIG. 1 is a schematic side view of an escalator, which may employ the teachings of the present invention;

FIG. 2 is a partial perspective view of the upper landing of the escalator of FIG. 1;

FIG. 3 is a perspective view of the machine of the escalator of FIG. 1;

FIG. 4 is another partial perspective view of the upper landing of the escalator of FIG. 1;

FIG. 5 is a partial perspective view of an upper landing of an escalator showing the application of a torque wrench to the motor, according to an exemplary embodiment of the present invention;

FIG. 6 is a flowchart outlining a brake torque inspection method according to an exemplary embodiment of the present invention; and

FIG. 7 is a top view of torque wrench being applied to a motor, according to an exemplary embodiment of the present invention.

While the present disclosure is susceptible to various modifications and alternative constructions, certain illustrative embodiments thereof will be shown and described below in detail. The invention is not limited to the specific embodiments disclosed, but instead includes all modifications, alternative constructions, and equivalents thereof.

### DETAILED DESCRIPTION

Although described in detail below as relating to an escalator, it will be understood that the brake torque inspection method disclosed herein may relate to any passenger conveyer, such as, including but not limited to, a moving walkway or elevator without departing from the scope of the invention. Furthermore, the disclosed brake torque inspection method may also apply to any braking system with an associated motor.

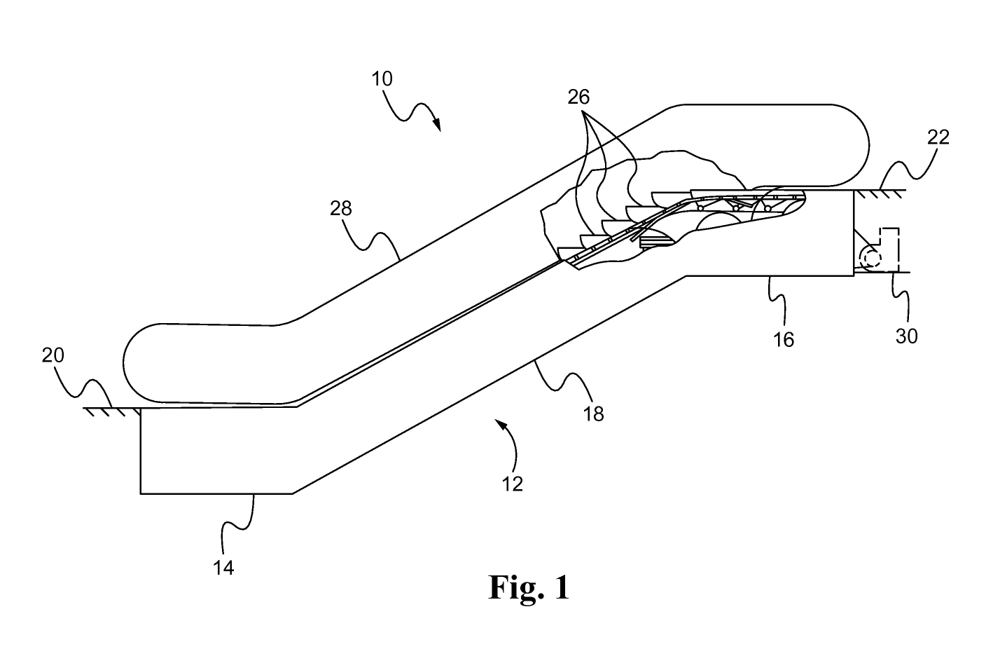

Turning now to FIG. 1, the schematic side view of an escalator 10 is shown. The escalator 10 includes a frame or truss 12, which extends from a lower elevation first end 14 to a higher elevation second end 16. The first end 14 and second end 16 are parallel to one another and are connected by an inclined midsection 18. The escalator 10 extends from a lower landing 20 to an upper landing 22.

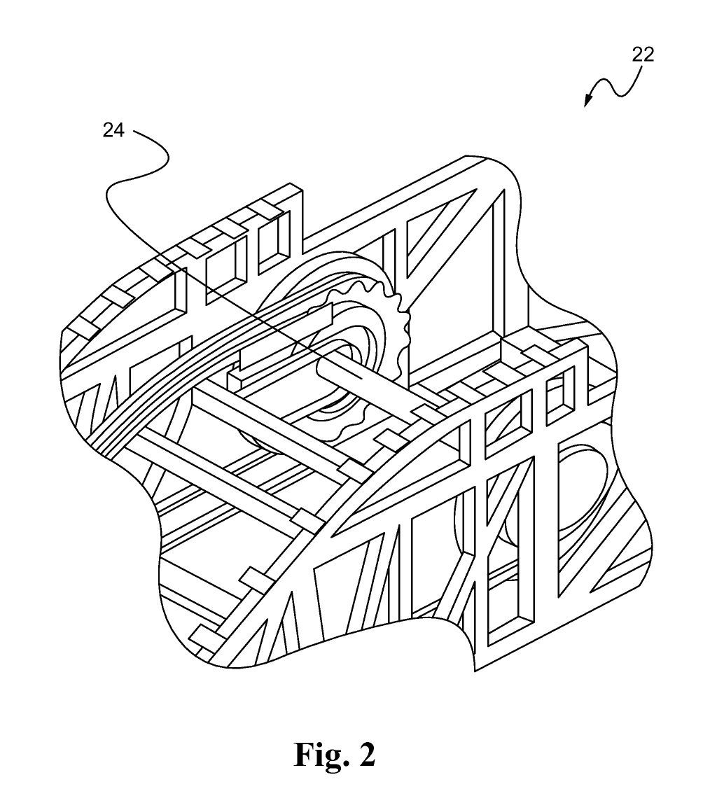

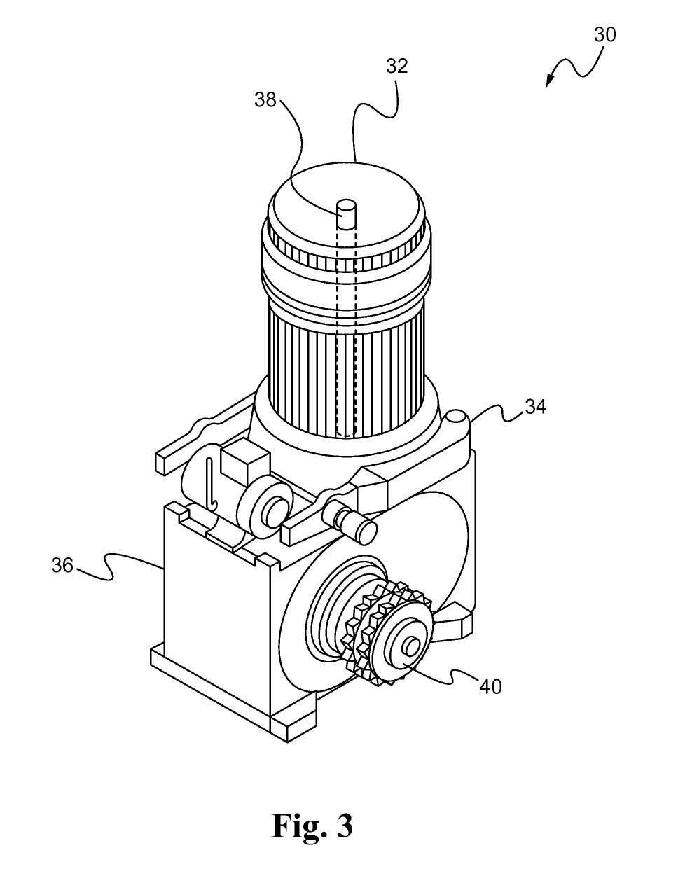

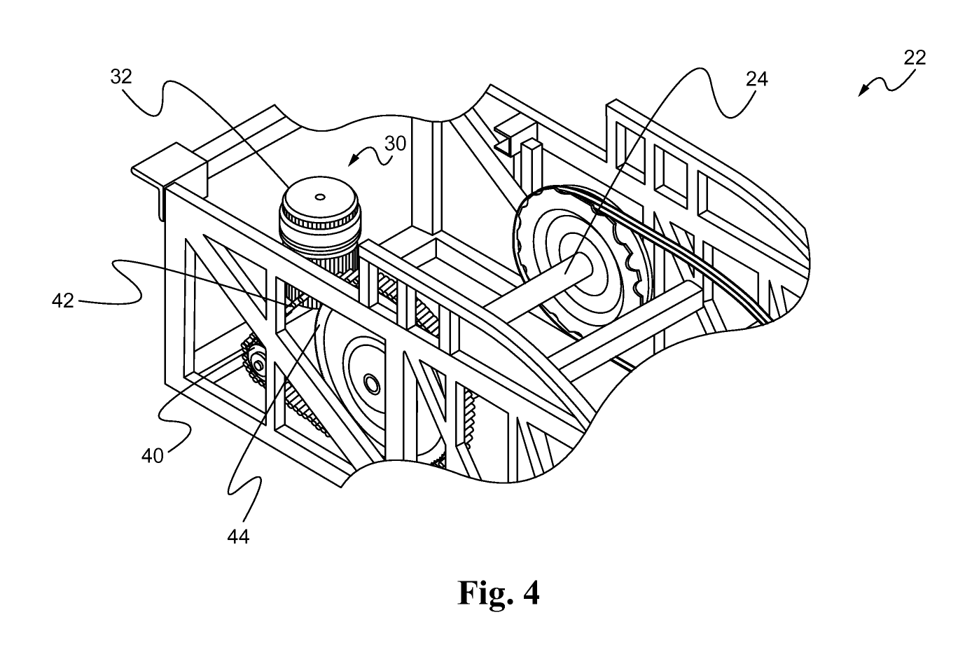

The upper landing 22 houses a main drive shaft 24 (FIG. 2), which drives steps 26 and handrail 28. The main drive shaft 24 is powered by a drive machine 30, which provides the motive force for the escalator 10. As shown best in FIG. 3, the drive machine 30 may comprise an electric motor 32, a motor shaft 38, a machine brake 34, a gearbox 36, and an output shaft (not shown). The motor 32 of the drive machine 30 converts electrical energy into mechanical energy, which is translated to the gearbox 36 through the motor shaft 38. Situated between the motor 32 and gearbox 36, the machine brake 34 provides braking action to the motor 32. The gearbox 36 increases the torque from the motor shaft 38 and transmits that increased torque to a machine drive sprocket 40 through the output shaft. It will be understood that the drive machine may also be gearless without departing from the scope of the invention. As shown best in FIG. 4, a main drive chain 42 transfers the torque from the machine drive sprocket 40 to a main drive sprocket 44, which is coupled to the main drive shaft 24. The relative diameters of the machine drive sprocket and the main drive sprocket further increase the transmission ratio between the drive machine and the main drive shaft.

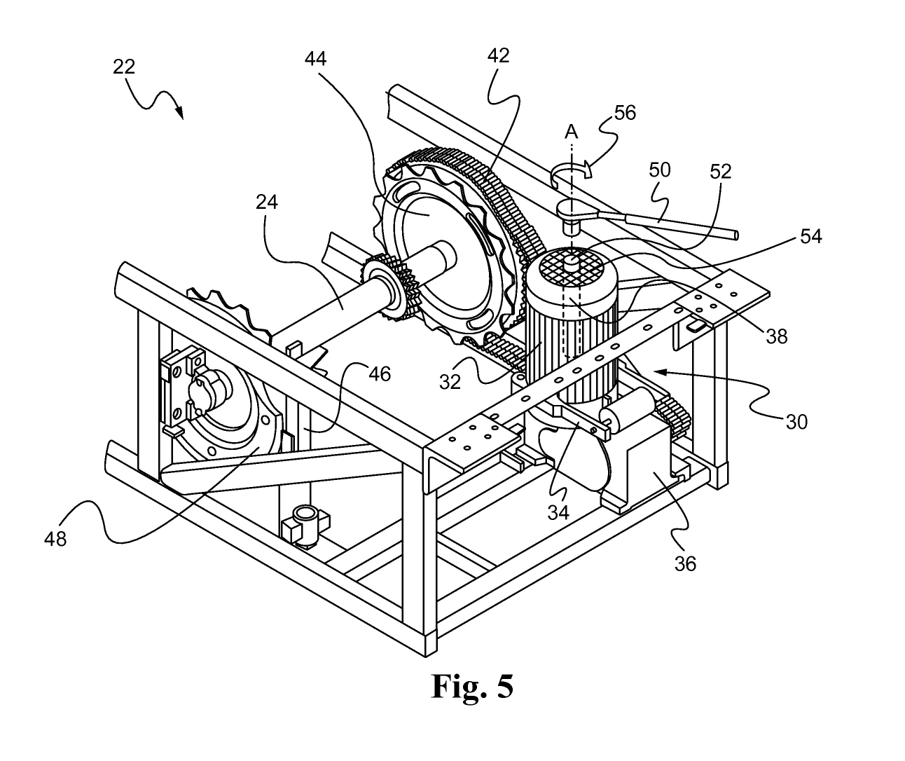

Turning now to FIG. 5, to stop the escalator 10, a main drive shaft brake and/or an auxiliary brake 46 is applied to the main drive shaft 24. The main drive shaft brake is used in normal operation, while the auxiliary brake 46 is used as a redundant brake in the even there is a failure in the main drive system. The auxiliary brake 46 exerts a frictional force on a brake disk 48, which is affixed to the main drive shaft 24, causing the main drive shaft 24 to stop moving. The auxiliary brake 46 should be able to apply a minimum amount of brake torque to the main drive shaft 24 to ensure that the auxiliary brake 46 is working sufficiently for the safety of passengers riding on the escalator 10. Local safety codes mandate what the required minimum amount of brake torque is, depending on the design and dimensions of the escalator 10, and typically mandate periodic testing to ensure compliance with the safety code.

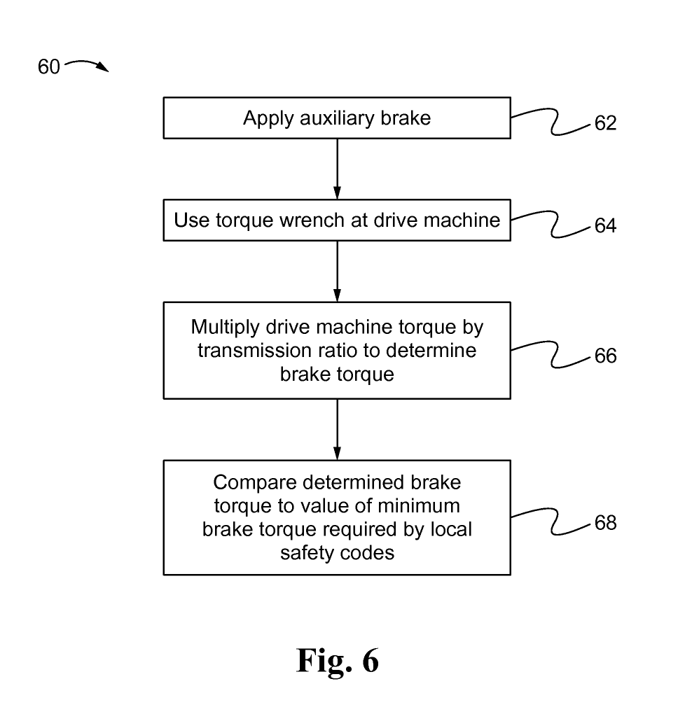

According to an exemplary embodiment of the present invention, a torque wrench 50 may be applied to the drive machine 30 to test the brake torque of the auxiliary brake 46. The flowchart in FIG. 6 illustrates an exemplary method 60 for inspecting brake torque. At first step 62, the auxiliary brake 46 is applied or set in the braking position. The braking position is the position in which the auxiliary brake 46 stops the main drive shaft 24 and escalator 10 from moving.

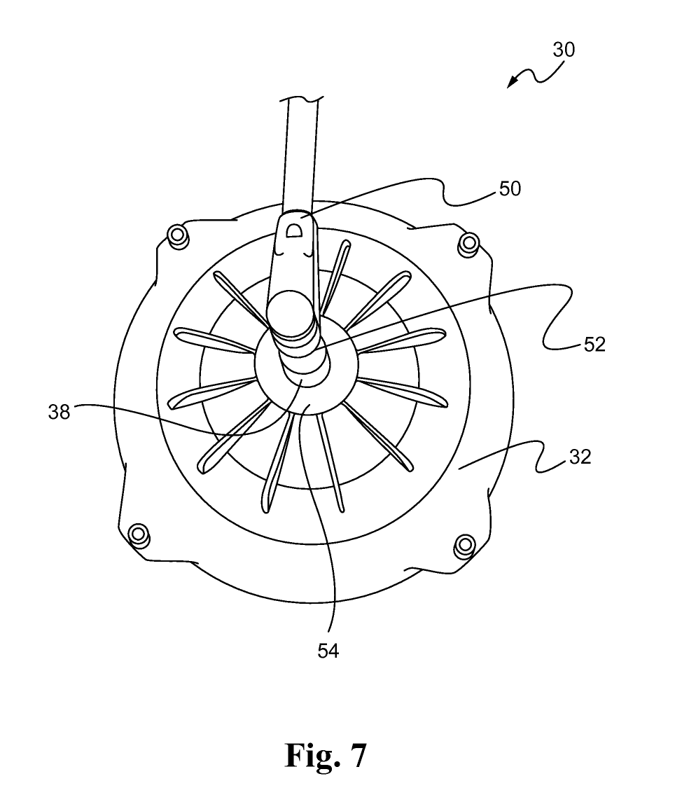

Once the auxiliary brake 46 is applied, at step 64, the torque wrench 50 may be used at the drive machine 30 to measure the brake torque. As shown best in FIG. 7, the torque wrench 50 may be adapted to engage with an end 52 of the motor shaft 38 at a top 54 of the motor 32 of the drive machine 30. The torque wrench 50 may be in the form of a socket wrench and may be configured to measure the torque applied to the drive machine 30. By using the torque wrench 50 to rotate the motor 32 about its central axis A (FIG. 5), a drive machine torque may be determined. For example, an operator may apply torque on the motor shaft 38 of the motor 32 in the direction of arrow 56 shown in FIG. 5, until the auxiliary brake 46 can no longer stop the main drive shaft 24 from moving. Alternatively, the operator may also apply the torque wrench at the output shaft of the gearbox 36 to determine the drive machine torque. The operator may then record the drive machine torque measurement on the torque wrench 50 at this moment. The moment at which the auxiliary brake 46 can no longer stop the movement of the main drive shaft 24 when torque is applied at the drive machine 30 determines the full load brake torque of the auxiliary brake 46.

Referring back to FIG. 6, at step 66, the determined drive machine torque may be multiplied by a transmission ratio to determine the full load brake torque, or the torque at which the auxiliary brake 46 can no longer stop the main drive shaft 24 from moving. The transmission ratio is the ratio of the brake torque at the auxiliary brake 46 to the torque at the drive machine 30. The transmission ratio may depend on at least one transmission element configured to transfer power from the drive machine 30 to the main drive shaft 24. For example, the transmission elements may include the motor shaft 38, gearbox 36, machine drive sprocket 40, main drive chain 42, and main drive sprocket 44 of the escalator 10. At step 68, the determined brake torque may then be compared to a value for the minimum amount of brake torque required by local safety codes to see whether or not the safety requirements for the auxiliary brake 46 of the escalator 10 are met.

In an alternative embodiment, a minimum required motor torque value may be calculated based on the minimum brake torque value mandated by local safety codes. For example, the minimum required brake torque value may be divided by the escalator's 10 transmission ratio to determine the minimum required motor torque value. The motor torque measurement obtained at step 66 may then be compared to the minimum required motor torque value to see whether or not the safety requirements for the auxiliary brake 46 of the escalator are met.

In another alternative embodiment, a predetermined torque value may be applied by the torque wrench 50 to either the motor shaft 38 or the output shaft of the drive machine 30 to determine if the predetermined torque will cause the motor shaft 38 or output shaft to turn. The predetermined torque value may be calculated from multiplying a minimum amount of brake torque required by local safety codes for a passenger conveyor by a transmission ratio. After the torque wrench 50 is set to the predetermined torque value, the torque wrench 50 may then be applied to the motor shaft 38 or output shaft to determine if the minimum torque will overcome the brake force and cause the motor shaft 38 to turn. If the torque wrench 50 turns the motor shaft 38 or output shaft, this signifies that the brake torque of the escalator auxiliary brake 46 is not set high enough. If the torque wrench 50 does not turn the motor shaft 38 or output shaft, this signifies that the brake torque at least meets the minimum safety requirements. In this way, the brake torque value is determined as a minimum brake torque value rather than an absolute brake torque value, wherein such determination may be sufficient to demonstrate compliance with requirements for the device.

### INDUSTRIAL APPLICABILITY

The brake torque inspection method disclosed herein may be used in a wide range of industrial or commercial applications, such as in escalator systems. By using the disclosed method, the full load brake torque of a braking system can be inspected, thereby ensuring passenger safety and ride quality of the escalator system.

Furthermore, the disclosed method provides a simplified, inexpensive, efficient and reliable way to inspect brake torque. By applying a torque wrench at the drive machine, brake torque inspection of escalator systems can be quickly and easily accomplished by a single operator. Thus, compared to the conventional brake torque inspection method of loading the escalator steps with a heavy and large weight load, many time, labor, and cost-saving advantages are provided by the present invention.

While the foregoing detailed description has been given and provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims appended hereto.

While some features are described in conjunction with certain specific embodiments of the invention, these features are not limited to use with only the embodiment with which they are described, but instead may be used together with or separate from, other features disclosed in conjunction with alternate embodiments of the invention.

What is claimed is:

1. A brake torque inspection method to a device having a drive machine and a driven component operatively connected to the drive machine, comprising:
applying a brake to the driven component; and
using a torque wrench at a shaft of the drive machine to determine the brake torque.

2. The method of claim 1, wherein the drive machine has a motor shaft and an output shaft.

3. The method of claim 2, further comprising using the torque wrench at the motor shaft to determine the torque at the drive machine.

4. The method of claim 2, further comprising using the torque wrench at the output shaft to determine the torque at the drive machine.

5. The method of claim 1, further comprising multiplying the drive machine torque by a transmission ratio to determine the brake torque.

6. The method of claim 1, further comprising comparing the determined brake torque to a minimum amount of brake torque required by local safety codes for a passenger conveyor.

7. The method of claim 1, wherein the brake and the drive machine are components of a passenger conveyor.

8. The method of claim 1, further comprising transferring power between the drive machine and driven component through at least one transmission element, the at least one transmission element comprising one of a gearbox, machine drive sprocket, main drive chain, and main drive sprocket.

9. The method of claim 1, further comprising applying a predetermined torque value by the torque wrench to the shaft to determine if the predetermined torque will cause the shaft to turn, wherein the predetermined torque value is calculated from multiplying a minimum amount of brake torque required by local safety codes for a passenger conveyor by a transmission ratio.

10. A method for inspecting the brake torque in a passenger conveyor, comprising:
setting an auxiliary brake of a passenger conveyor in a braking position, the auxiliary brake being operatively associated to a drive machine of the passenger conveyor; and
applying a torque wrench to the drive machine to determine the brake torque.

11. The method of claim 10, wherein the braking position is a position in which the auxiliary brake stops the passenger conveyor from moving.

12. The method of claim 10, wherein the drive machine includes a motor shaft, and the torque wrench is applied to the motor shaft of the drive machine.

13. The method of claim 10, wherein the torque wrench is adapted to engage with an end of the motor shaft at the top of a motor of the drive machine.

14. The method of claim 10, wherein the drive machine includes an output shaft, and the torque wrench is applied to the output shaft of the drive machine.

15. The method of claim 10, wherein a torque at the drive machine is determined by applying the torque wrench to the drive machine.

16. The method of claim 10, further comprising multiplying the torque at the drive machine by a transmission ratio to determine the brake torque.

17. The method of claim 12, further comprising applying a predetermined torque value by the torque wrench to the shaft to determine if the predetermined torque will cause the shaft to turn, wherein the predetermined torque value is calculated from multiplying a minimum amount of brake torque required by local safety codes for a passenger conveyor by a transmission ratio.

18. The method of claim 10, further comprising transferring power between the drive machine and driven component through at least one transmission element of the passenger conveyor, the at least one transmission element comprising one of a gearbox, machine drive sprocket, main drive chain, and main drive sprocket.

19. The method of claim 10, wherein the auxiliary brake is configured to stop the main drive shaft of the passenger conveyor.

20. The method of claim 10, further comprising comparing the determined brake torque to a minimum amount of brake torque required by local safety codes.

21. A method for testing brake torque in a passenger conveyor, comprising:
providing a passenger conveyor with a brake, a main drive shaft, and a drive machine;
applying the brake to the main drive shaft; and
using a torque wrench at the drive machine to test the brake torque, the drive machine being operatively configured to move the main drive shaft.

22. The method of claim 21, wherein a drive machine torque is determined by the torque wrench.

23. The method of claim 21, further comprising multiplying the drive machine torque by a transmission ratio to determine the brake torque.

24. The method of claim 21, further comprising comparing the determined brake torque to an acceptable value of brake torque for the passenger conveyor required by local safety codes.

25. The method of claim 21, further comprising applying a predetermined torque value by the torque wrench to the shaft to determine if the predetermined torque will cause the shaft to turn, wherein the predetermined torque value is calculated from multiplying a minimum amount of brake torque required by local safety codes for a passenger conveyor by a transmission ratio.

26. The method of claims 23, further comprising transferring power between the drive machine and driven component through at least one transmission element of the passenger conveyor, the at least one transmission element comprising one of a gearbox, machine drive sprocket, main drive chain, and main drive sprocket.

27. The method of claim 21, wherein the drive machine includes a motor shaft and an output shaft, and wherein the torque wrench is applied to either the motor shaft or the output shaft.

28. The method of claims 21, wherein the passenger conveyor comprises an escalator, a moving walkway, or an elevator.
